(19) United States
(12) Patent Application Publication
(10) Pub. No.: US 2026/0291130 A1
(43) Pub. Date: Sep. 24, 2026

(54) ELECTRICAL CONNECTOR WITH IMPROVED HIGH FREQUENCY PERFORMANCE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: FANG-JWU LIAO, New Taipei (TW); Jia-Hau Liu, New Taipei (TW); Chia-Ru Chang, New Taipei (TW)

(21) Appl. No.: 19/569,413

(22) Filed: Mar. 17, 2026

(30) Foreign Application Priority Data
Mar. 18, 2025 (CN) 202520474476.2

(51) Int. Cl. H01R 13/6471; H01R 12/70; H01R 12/71; H01R 13/50

(52) U.S. Cl. CPC H01R 13/6471; H01R 12/7082; H01R 12/714; H01R 13/50

(57) ABSTRACT

An electrical connector includes an insulating housing having a plurality of terminal grooves penetrating in an upper-lower direction, and a plurality of terminals retained in corresponding terminal grooves. The terminals include a row of grounding terminals and plural rows of functional terminals arranged along a first direction. Each functional terminal includes a retaining portion and two elastic arms extending from the retaining portion. The functional terminals located at one side of the row of the grounding terminals form a first functional region and the functional terminals located at the other side of the row of the grounding terminals form a second functional region. The elastic arms of the function terminals in the first functional region and the second functional region all extend toward the row of the grounding terminals or all extend away from the row of the grounding terminals.

### BACKGROUND OF THE INVENTION

### Field of the Invention

The present invention relates to an electrical connector.

### Description of Related Arts

U.S. Pat. No. 11,381,023 discloses an electrical connector having an insulating housing and plural signal terminals. For the electrical connector, no shielding exists between two adjacent signal terminals and therefore there may be severe signal crosstalk between two adjacent signal terminals. As a transmission rate of current electrical connectors is getting higher and higher, and for some electrical connectors, the transmission rate even reaches 128 Gbps, how to reduce crosstalk between adjacent signal terminals is becoming more and more important.

Therefore, it is desired to provide an electrical connector with improved high frequency performance.

### SUMMARY OF THE INVENTION

An object of the present invention is to provide an electrical connector with improved high frequency performance.

To achieve the above object, an electrical connector includes an insulating housing having an upper face, a lower face, and a plurality of terminal grooves penetrating the upper face and the lower face in an upper-lower direction; and a plurality of terminals retained in corresponding terminal grooves, wherein the terminals include a row of grounding terminals and plural rows of functional terminals arranged along a first direction, each functional terminal includes a retaining portion and two elastic arms extending from the retaining portion, the functional terminals located at one side of the row of the grounding terminals form a first functional region and the functional terminals located at the other side of the row of the grounding terminals form a second functional region, and the elastic arms of the functional terminals in the first functional region and the second functional region all extend toward the row of the grounding terminals or all extend away from the row of the grounding terminals.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of this invention;

FIG. 2 is another perspective view of the electrical connector in FIG. 1, wherein two functional terminals and a grounding terminal are removed from an insulating housing;

FIG. 3 is a top view of the electrical connector in FIG. 1;

FIG. 4 is a perspective view of the functional terminals and the grounding terminals of the electrical connector in FIG. 1, wherein the insulating housing is removed;

FIG. 5 is a perspective view of two functional terminals;

FIG. 6 is a perspective view of the grounding terminal in FIG. 2;

FIG. 7 is a perspective view of a grounding terminal in another embodiment; and

FIG. 8 is a perspective view of a grounding terminal in still another embodiment.

### DETAILED DESCRIPTION OF THE PREFERRED EMBODIMENT

Reference will now be made in detail to the preferred embodiments of the present invention.

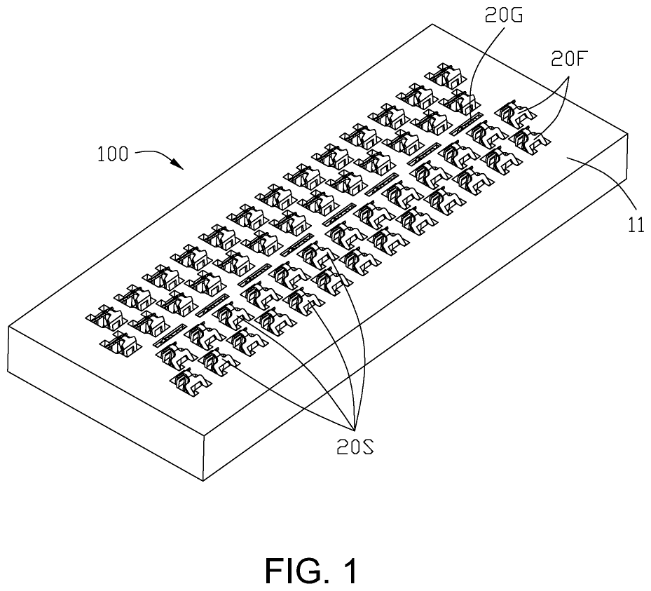

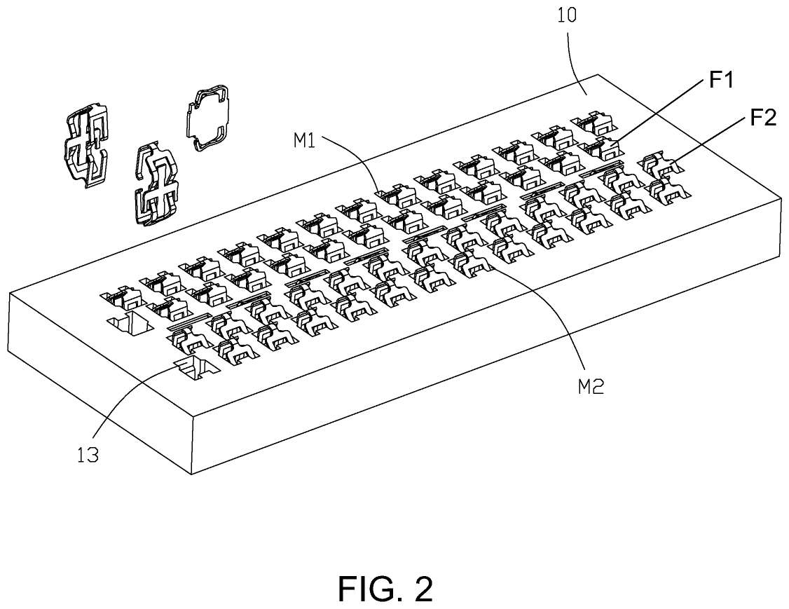

Referring to FIGS. 1-4, an electrical connector 100 is used for electrically connecting an electrical module, e.g., a chip module, to a circuit board or connecting two circuit boards. The electrical connector 100 includes an insulating housing 10 and a plurality of terminals 20 arranged in a matrix. The insulating housing 10 is provided with an upper face 11, a lower face (not labeled), and a plurality of terminal grooves 13 penetrating the upper face 11 and the lower face. The terminals 20 are retained in corresponding terminal grooves 13 one by one respectively. It should be noted that, in fact, the electrical connector 100 has hundreds of terminals. In the invention, only a portion of terminals 20 and terminal grooves 13 are illustrated.

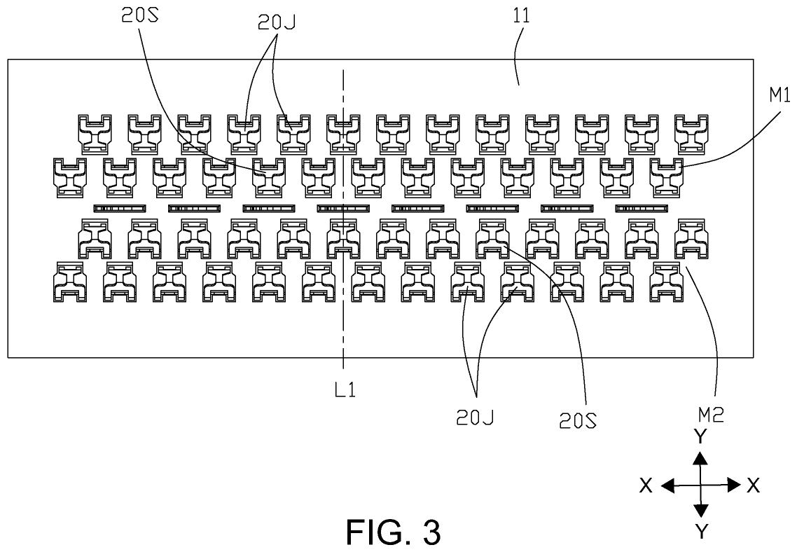

Referring to FIGS. 3-5, the terminals 20 include a row of grounding terminals 20G arranged in a first direction X-X and a plurality of functional terminals 20F. The functional terminals 20F are located at both sides of the row of the grounding terminals 20G. Each functional terminal 20F includes a retaining portion 200 and two elastic arms 201 extending from the retaining portion 200. The functional terminals 20F located at one side of the row of grounding terminals 20G form a first functional region M1 while those at the other side form a second functional region M2. The elastic arms 201 of the functional terminals 20F in both the first functional regions M1 and the second functional regions M2 extend from their respective retaining portions 200 in a direction toward the grounding terminals 20G. Alternatively, the elastic arms 201 of the functional terminals 20F in both the first functional regions M1 and the second functional regions M2 extend from their respective retaining portions 200 in a direction away from the grounding terminals 20G. Both the first functional region M1 and the second functional region M2 include a plurality of signal terminals 20S arranged at intervals, and each signal terminal 20S directly opposite the corresponding grounding terminal 20G. In order to achieve a better signal shielding, the grounding terminals 20G are sheet-shaped, and a center line L1 of the functional regions is perpendicular to a plane where the grounding terminals 20G are located.

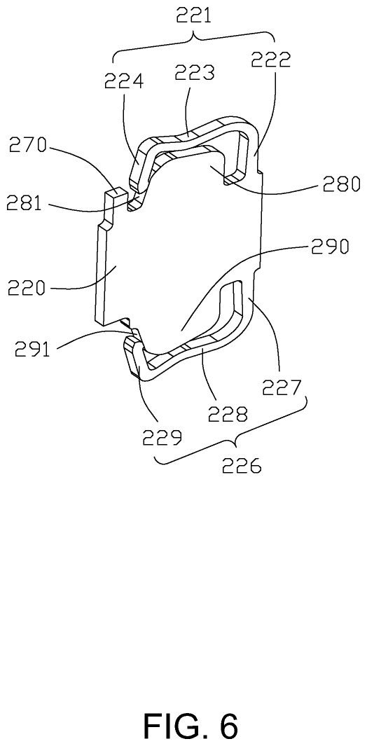

Combined with FIG. 6, preferably, the grounding terminal 20G includes a vertical main portion 220, an upper elastic arm 221 extending upward from the main portion 220, and a lower elastic arm 226 extending downward from the main portion 220. The main portion 220 is fixed in the corresponding terminal groove 13 by its two side edges hard interfered with an inner wall of the terminal groove 13. The main portion 220 includes an upper cutting face, a lower cutting face, a left cutting face, a right cutting face, and two vertical side faces. The upper elastic arm 221 sequentially includes an upper extension portion 222 extending upward from the upper cutting face, a transverse portion 223 extending leftward from the upper extension portion 222, and an upper abutting portion 224 extending downward from the transverse portion 223. In the embodiment, the grounding terminal further includes an upper island portion 280 protruding upward from the upper cutting face and located below the upper elastic arm 221. The upper island portion 280 and the main portion 220 are located in a same vertical plane, and the upper island portion 280 forms an upper contacting face 281 along a thickness thereof.

Similarly, the lower elastic arm 226 sequentially includes a lower extension portion 227 extending downward from the lower cutting face, a transverse portion 228 extending leftward from the lower extension portion 227, and a lower abutting portion 229 extending upward from the transverse portion 228. The grounding terminal 20G further includes a lower island portion 290 protruding downward from the lower cutting face and located over the lower elastic arm 226. The lower island portion 290 and the main portion 220 are located in the same vertical plane, and the lower island portion 290 is provided with a lower contacting face 291 formed along the thickness thereof. Both the upper contacting face 281 and the lower contacting face 291 are inclined. The junction of the transverse portion 223 and the upper abutting portion 224 forms an upper contacting portion, and the junction of the transverse portion 228 and the lower contacting portion 229 forms a lower contacting portion.

When the upper elastic arm 221 or the lower elastic arm 226 are pressed, that is, a chip or a circuit board contacts the upper contacting portion or the lower contacting portion, the upper abutting portion 224 contacts the upper contacting face 281, and the lower abutting portion 229 contacts the lower contacting face 291. In addition, to facilitate the installation of the grounding terminals 20G, the grounding terminal 20G further includes a strip connecting portion 270 at a left side of the upper island portion 280. The row of grounding terminals are integrally connected by a carrier strip connected with the strip connecting portions 270 of the grounding terminals 20G, enabling the grounding terminals 20G to be inserted into the insulating housing 10 as a whole. The strip connecting portion 270 extends upward from the upper cutting face of the main portion 220 and is spaced with the upper contacting face 281 at a left side of the upper island portion 280 away from the upper extension portion 222, that is, the upper island portion 280 is between the strip connecting portion 270 and the upper extension portion 222.

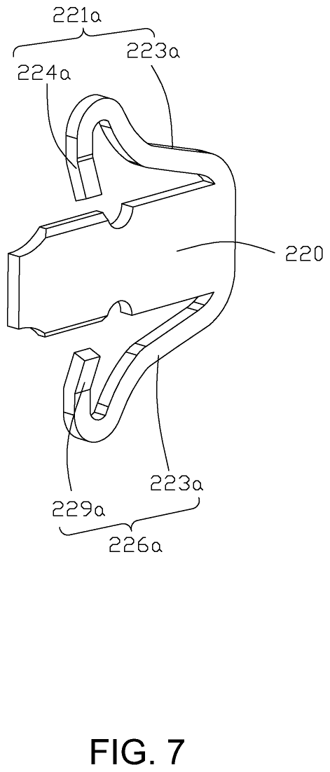

In other embodiments, the sheet-shaped grounding terminal 20G can also be configured in other shapes. Referring to FIG. 7, the sheet-shaped terminal 20G includes a vertical main portion 220, an upper elastic arm 221a extending upward from the main portion 220, and a lower elastic arm 226a extending downward from the main portion 220. The difference lies in that the upper elastic arm 221a only includes a transverse portion 223a and an upper abutting portion 224a. Similarly, the lower elastic arm 226a only includes a transverse portion 223a and a lower abutting portion 229a. When the upper elastic arm 221a and lower elastic arm 221a are pressed, the upper abutting portion 224a abuts against the upper cutting face and side face of the main portion 220, and the lower abutting portion 229a abuts against the lower cutting face and side face of the main portion 220. It is noted that, in the invention, the term “transverse portion” does not mean that the transverse portion only extends in a transverse direction/the first direction X-X, the transverse portion can also change in other directions as the transverse portion extends. For example, the transverse portion 223a changes in both the transverse direction and a vertical direction. In other embodiments, the grounding terminals 20 in the same row can also be connected together by connecting portions to form an integral grounding sheet. That is, after the grounding terminals 20G are inserted into the insulating housing 10, the grounding terminals 20G are not independent, and the left cutting face and right cutting face of each two adjacent grounding terminals 20G are connected by the connecting portion therebetween to make the grounding terminals as a whole.

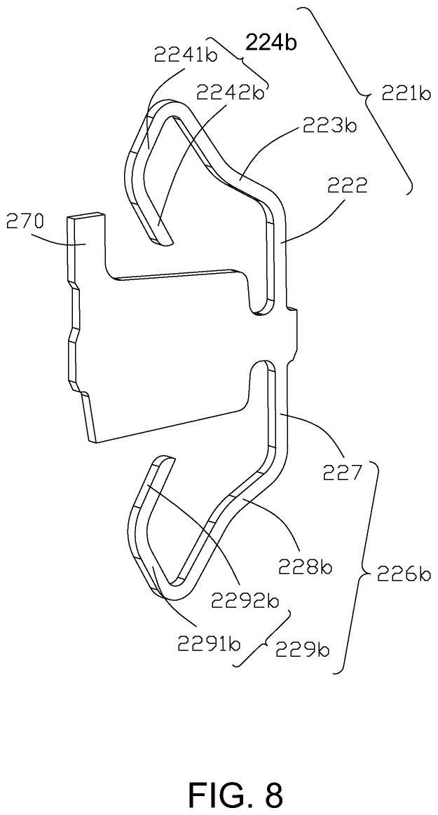

Referring to FIG. 8, a grounding terminal 20G in another embodiment of the present invention is illustrated. The grounding terminal 20G includes an upper elastic arm 221b extending upward from the main portion 220 and a lower elastic arm 226b extending downward from the main portion 220. The upper elastic arm 221b sequentially includes an upper extension portion 222 vertically extending from the upper cutting face, a transverse portion 223b, and an upper abutting portion 224b. The lower elastic arm 226b sequentially includes a lower extension portion 227 vertically extending from the lower cutting face, a transverse portion 228b, and a lower abutting portion 229b. A junction between the transverse portion 223b and the upper abutting portion 224b forms an upper contacting portion, and a junction between the transverse portion 228b and the lower abutting portion 229b forms a lower contacting portion. When the grounding terminal 20G is pressed, the upper abutting portion 224b contacts the upper cutting face, and the lower abutting portion 229b contacts the lower cutting face. Preferably, to ensure better contacting between the upper abutting portion 224b and the upper cutting face, and the lower abutting portion 229b and the lower cutting face respectively, and minimize the size of the grounding terminal 20G as much as possible, the upper abutting portion 224b includes a first segment 2241b inclining downward and away from the upper extension portion 222 in the first direction X-X from the upper contacting portion, and a second segment 2242b inclining downward and toward the upper extension portion 222 in the first direction X-X from the first segment 2241b. Similarly, the lower abutting portion 229b includes a first segment 2291b inclining upward and away from the lower extension portion 227 along the first direction X-X from the lower contacting portion, and a second segment 2292b inclining upward and toward the lower extension portion 227 in the first direction. When the grounding terminal 20G is pressed, the second segment 2242b contacts the upper cutting face, and the second segment 2292b contacts the lower cutting face respectively. Preferably, both the upper cutting face and the lower cutting face extend horizontally for better contacting with the second segments 2242b, 2292b respectively. The grounding terminal 20G includes a strip connecting portion 270 extending upward from the upper cutting face, and the strip connecting portion 270 is located at one end of the upper cutting face away from the upper extension portion 222.

Referring to FIGS. 1-3, the first functional region M1 includes at least two rows of functional terminals 20F, and two adjacent signal terminals 20S are separated by two spare terminals 20J. Additionally, adjacent rows of functional terminals 20F in the same functional region are staggered along the first direction. In this way, the signal terminals 20S in adjacent rows within the same functional region are not aligned in the second direction Y-Y perpendicular to the first direction X-X, thereby reducing interference between signal terminals in the second direction Y-Y. Preferably, in the same functional region, the signal terminals 20S in one row are positioned directly opposite a gap between two spare terminals 20J in an adjacent row in the second direction. Preferably, two rows of functional terminals 20F at two sides of and immediately adjacent to the row of the grounding terminals 20G are staggered along the first direction. In other words, when a row of the functional terminals 20F at one side of the row of grounding terminals 20G is called F1, and a row of the functional terminals 20F at the other side of the row of grounding terminals 20G is called F, F1 is staggered with F2 along the first direction.

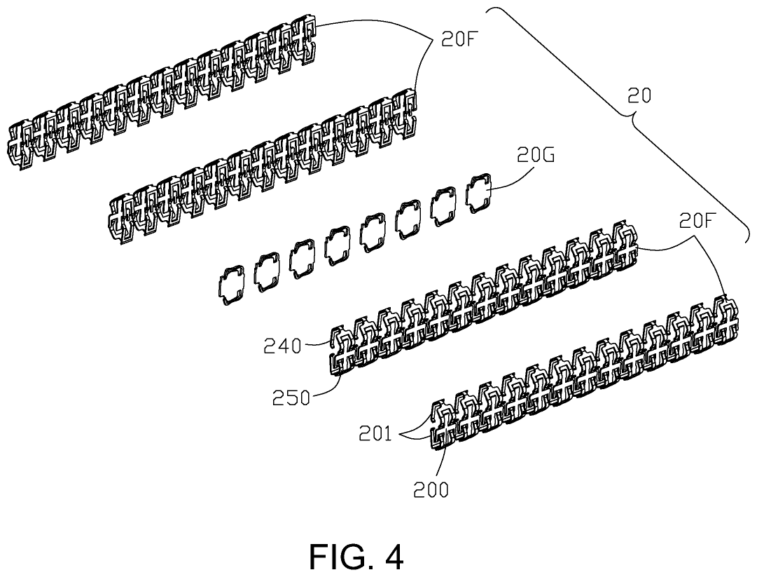

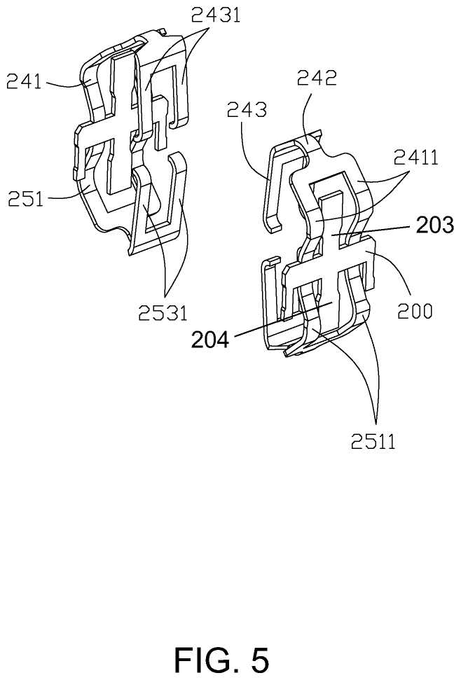

Referring to FIGS. 4-5, in the embodiment, the elastic arm 201 of the functional terminal 20 includes an upper elastic arm 240 extending upward from the retaining portion 200 and a lower elastic arm 250 extending downward from the retaining portion 200. The retaining portion 200 extends vertically and is arranged parallel to the main portion 220 of the grounding terminal 20G. The upper elastic arm 240 sequentially includes an upper elastic portion 241, an upper contacting portion 242, and an upper abutting portion 243. The upper elastic portion 241 includes two upper sub-arms 2411 arranged at intervals, and the upper abutting portion 243 includes two upper abutting arms 2431 spaced apart from each other. Similarly, the lower elastic arm 250 sequentially includes a lower elastic portion 251, a lower contacting portion 252, and a lower abutting portion 253. The lower elastic portion 251 includes two lower sub-arms 2511 arranged at intervals, and the lower abutting portion 253 includes two lower abutting arms 2531 arranged at intervals. When the upper elastic arms 240 and lower elastic arms 250 of the functional terminals 20 are pressed, the two upper abutting arms 2431 and the two lower abutting arms 2531 abut against with each other respectively. The functional terminal 20 further includes an upper stub 203 extending vertically upward from the retaining portion 200, and a lower stub 204 extending vertically downward from the retaining portion 200. The upper stub 203 is between the two upper sub-arms 2411 and the lower sub 204 is between the two lower sub-arms 2511.

It should be noted that, the electrical connector 100 may have hundreds of terminals and the figures of the invention only schematically show a portion of the terminals 20 and the terminal grooves 13 that accommodate these terminals. For actual products, the first functional region M1 has dozens or hundreds of rows of functional terminals 20F arranged along the first direction, and similarly, the second functional region M2 also has dozens or hundreds of rows of functional terminals 20F arranged along the first direction. In the embodiment, the elastic arms 201 of the functional terminals 20F in the first functional region M1 and the second functional region M2 all extend from their respective retaining portions 200 and toward the row of the grounding terminal 20G. Alternatively, in other embodiments, the elastic arms 201 of the functional terminals 20F in the first functional region M1 and the second functional region M2 can also extend from their respective retaining portions 200 and away from the row of the grounding terminals 20G. Preferably, in other embodiments, the elastic arms of the functional terminals 20F of one of the first functional region M1 and second M2 are configured to extend toward the row of grounding terminals 20G, while the elastic arms of the functional terminals 20F of the other are configured to extend away from the row of the grounding terminal 20G.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing having an upper face, a lower face, and a plurality of terminal grooves penetrating the upper face and the lower face in an upper-lower direction; and
a plurality of terminals retained in corresponding terminal grooves;
wherein the terminals comprise a row of grounding terminals and plural rows of functional terminals arranged along a first direction, each functional terminal comprises a retaining portion and two elastic arms extending from the retaining portion, the functional terminals located at one side of the row of the grounding terminals form a first functional region and the functional terminals located at the other side of the row of the grounding terminals form a second functional region, and the elastic arms of the functional terminals in the first functional region and the second functional region all extend toward the row of the grounding terminals or all extend away from the row of the grounding terminals.

2. The electrical connector as claimed in claim 1, wherein each of the first functional region and the second functional region comprises plural signal terminals and spare terminals, and two adjacent signal terminals in a same row are spaced by at least one spare terminal.

3. The electrical connector as claimed in claim 2, wherein the signal terminals are directly opposite corresponding grounding terminals in a second direction perpendicular to the first direction.

4. The electrical connector as claimed in claim 1, wherein two adjacent rows of functional terminals in the first functional region are staggered along the first direction.

5. The electrical connector as claimed in claim 4, wherein a center line of the functional terminals is perpendicular to a plane where the grounding terminals are located.

6. The electrical connector as claimed in claim 1, wherein the two rows of functional terminals at two opposite sides of the row of the grounding terminals are staggered along the first direction.

7. The electrical connector as claimed in claim 1, wherein the grounding terminal is sheet-shaped and comprises a vertical main portion and an upper resilient arm extending upward from the main portion, the main portion includes an upper cutting face and a lower cutting face along a thickness direction thereof, the upper resilient arm sequentially includes an upper extension portion vertically extending from the upper cutting face, a transverse portion, and an upper abutting portion, and the upper abutting portion abuts against the upper cutting face when the upper resilient arm is pressed.

8. The electrical connector as claimed in claim 1, wherein the elastic arms of each functional terminal comprise an upper elastic arm extending upward from the retaining portion and a lower elastic arm extending downward from the retaining portion, the upper elastic arm sequentially includes an upper elastic portion, an upper contacting portion, and an upper abutting portion, the upper elastic portion comprises two upper sub-arms arranged at intervals, and the upper abutting portion includes two upper abutting arms spaced apart from each other.

9. The electrical connector as claimed in claim 8, wherein the lower elastic arm sequentially includes a lower elastic portion, a lower contacting portion, and a lower abutting portion, the lower elastic portion comprises two lower sub-arms arranged at intervals, the lower abutting portion includes two lower abutting arms spaced apart from each other, and the two upper abutting arms abut against the two lower abutting arms respectively when the upper elastic arm and the lower elastic arm are pressed.

10. The electrical connector as claimed in claim 9, wherein the functional terminal comprises an upper stub extending vertically upward from the retaining portion and a lower stub extending vertically downward from the retaining portion, and the upper stub is between the two upper sub-arms and the lower sub is between the two lower sub-arms.

11. The electrical connector as claimed in claim 1, wherein the grounding terminal is sheet-shaped and comprises a vertical main portion, an upper resilient arm extending upward from the main portion, and a lower resilient arm extending downward from the main portion, the main portion includes an upper cutting face and a lower cutting face along a thickness direction thereof, the upper resilient arm is over the upper cutting face and abuts against the main portion when the upper resilient arm is pressed, and the lower resilient arm is under the lower cutting face and abuts against the main portion when the lower resilient arm is pressed.

12. The electrical connector as claimed in claim 11, wherein the elastic arm of each functional terminal comprises an upper elastic arm extending upward from the retaining portion and a lower elastic arm extending downward from the retaining portion, and the retaining portion is parallel to the main portion.

13. An electrical connector comprising:
an insulating housing; and
a plurality of terminals retained in corresponding terminal grooves;
wherein the terminals comprise a row of grounding terminals arranged along a first direction and plural rows of functional terminals at each side of the row of grounding terminals, each grounding terminal comprises a vertical main portion and an upper resilient arm, the main portion has an upper cutting face and a lower cutting face along a thickness direction thereof, the upper resilient arm extends upward and leftward from the upper cutting face for abutting against the main portion when the upper resilient is pressed, each functional terminal comprises a retaining portion and two elastic arms extending from the retaining portion, and a center line of each of the functional terminals is perpendicular to a plane where the grounding terminals are located.

14. The electrical connector as claimed in claim 13, wherein the elastic arms of the functional terminals at two sides of the row of the grounding terminals extend from corresponding retaining portion toward the row of the grounding terminals.

15. The electrical connector as claimed in claim 13, wherein two adjacent rows of functional terminals at a same side of the grounding terminals are staggered along the first direction.

16. The electrical connector as claimed in claim 13, wherein each row of the functional terminals comprises plural signal terminals, and each signal terminal is directly opposite corresponding grounding terminal in a second direction perpendicular to the first direction.

17. The electrical connector as claimed in claim 13, wherein two adjacent signal terminals in the same row are separated by two spare terminals.

18. An electrical connector comprising:
an insulating housing; and
a row of grounding terminals arranged in a first direction, a first functional region and a second functional region being arranged at opposite sides of the row of grounding terminals, each of the first functional region and the second functional region comprising rows of functional terminals, each of the functional terminals comprising a retaining portion and two elastic arms extending from opposite ends of the retaining portion;
wherein the elastic arms of the function terminals in the first functional region extend toward the row of the grounding terminals, and the elastic arms of the function terminals in the second functional region extend toward the row of the grounding terminals and directly opposite to the elastic arms of the function terminals in the first functional region.
